(19) United States
(12) Patent Application Publication
(10) Pub. No.: US 2016/0001782 A1
(43) Pub. Date: Jan. 7, 2016

(54) Method and device for identifying a driver of a vehicle

(71) Applicant: Robert Bosch GmbH, Stuttgart (DE)

(72) Inventor: Thomas FIEDLER, Moessingen (DE)

(21) Appl. No.: 14/753,726

(22) Filed: Jun. 29, 2015

(30) Foreign Application Priority Data
Jul. 2, 2014 (DE) 10 2014 212 758.0

(51) Int. Cl. B60W 40/09

(52) U.S. Cl. CPC B60W 40/09; B60W 2040/0809

(57) ABSTRACT

In a method for identifying a driver of a vehicle, it is ascertained to what extent the driver is authorized to operate the vehicle, and the option of automatically adapting settings of the vehicle to individual users of the vehicle is provided. The identification of the driver, i.e., the recognition of an authorized user or a particular person who is an authorized user initially takes place by acquiring at least one operating parameter of the vehicle. The temporal behavior of this operating parameter then is compared to correspondingly stored comparison data in order to allow an identification of the driver or the user of the vehicle.

### BACKGROUND OF THE INVENTION

1. Field of the Invention

The present invention relates to a method and a device for identifying a driver of a vehicle.

2. Description of the Related Art

In an effort to prevent unauthorized use, but also in order to allocate the use to specific persons, e.g., in the form of person-specific accounting, it may be required to ascertain the identity of the user of a vehicle.

In addition to the general input of a user ID prior to the start of travel, German patent application publication DE 10 2004 062 641 A1, for example, describes a system in which an RFID identification is employed to identify the driver. Another option for the identification is the use of biometric data, such as an image of a body part, as illustrated in the German patent application publication DE 103 21 750 A1, for instance.

From the international patent application publication WO 2009/142920 A1, it is known that in addition to enabling the operation, the identification of the driver of the vehicle may also be utilized for adapting different interior and exterior settings of the vehicle to the driver or for adapting different components to the driving style of the driver.

### BRIEF SUMMARY OF THE INVENTION

The present invention provides a method and a device which are used for identifying the driver of a vehicle. In the process it is ascertained to what extent the driver is authorized to operate the vehicle, and the option for automatically adapting settings of the vehicle to individual users of the vehicle is provided.

Such identifications may be used both in motor vehicles such as trucks, passenger cars or motorcycles, and for vehicles which are at least partially operated by muscle power, such as bicycles, especially electrically drivable bicycles.

The identification of the driver, i.e., the recognition of an authorized user or a particular person who is an authorized user initially takes place by acquiring at least one operating parameter of the vehicle. The temporal behavior of this operating parameter then is compared to correspondingly stored comparison data in order to allow an identification of the driver or the user of the vehicle. In the event that the acquired operating parameter can be allocated to a driver via the comparison data, an identification signal is output, e.g., in the form of positive feedback. However, if the operating parameters do not correspond to any comparison data, either no identification signal or negative feedback is generated and possibly output.

Taking the operating parameters of the vehicle into account makes it possible to record the user behavior during the operation. For example, the power take-off behavior, the acceleration behavior or also the cornering behavior may exhibit an individual characteristic that can be assigned to the driver of the vehicle. Comparing these operating parameters to stored user profiles of the corresponding variables makes it possible to identify the driver. This identification may furthermore be utilized to adapt settings on the vehicles to the individual driver, without requiring an explicit manual adjustment. Furthermore, this identification may also be utilized for accounting purposes, e.g., in the case of car or bike sharing, or as theft protection.

In addition to an operating parameter, personal parameters of the driver can be recorded for identification purposes as well. For instance, a fingerprint, the heart rate, the weight or also other biometric parameters are able to be utilized.

The additional recording of biometric parameters enables the release of the vehicle in a first step, while the operating parameters adjust different operating modes of the vehicle. Furthermore, the biometric parameters may also be utilized for different operating modes, e.g., greater assistance of a partially electrically driven bicycle once an excessive heart rate has been detected.

As typical operating parameters, which represent the operation or the driving behavior of the vehicle, suitable sensors may record
a torque, especially of a foot pedal or a motor, and/or
an acceleration, especially of a foot pedal of a bicycle or the vehicle, and/or
a rotational frequency, especially of a motor, and/or
a pedaling frequency of a foot pedal of a bicycle, and/or
an inclination of the vehicle, and/or
an ascending gradient of the vehicle during its operation
   and use these variables for identifying the driver. Through the recording of at least two operating parameters, the individual driving behavior, and thus the identification of a specific person, is able to take place even more rapidly and/or more unambiguously.

Another option for identifying the driver is an analysis of the local movement pattern. To do so, a GPS signal can be acquired or generated in addition, from which the movement patterns of the vehicle are derived. If abnormal patterns are noticeable in these movement patterns, e.g., in that the movement of the vehicle occurs at atypical times, on atypical routes and/or in atypical areas, a further check of the identification may possibly be carried out or also the theft of the vehicle be inferred.

The (positive) identification, and thus the detection of or the allocation to a known driver, may additionally be utilized for activating or adjusting particular components of the vehicle. For example, if a driver who is authorized to use the vehicle is detected, the drive or also an operating element can be enabled for an external control. However, it is also possible that a certain basic drive is available to any driver, whereas a normal or otherwise also a more optimal use may be possible only after a correct identification. Similarly, operating elements or also comfort functionalities in or on the vehicle may additionally be enabled by the identification.

In the reverse case, the utilization of vehicle components can also be deactivated at least partially or blocked completely if the identification fails or supplies a negative result. For example, the drive of an electric bike may block or restrict the locomotion if it is detected after a certain period of time that the driver is not authorized. As an alternative, the operating element may also be switched off in order to prevent the use or at least to make it more difficult.

### BRIEF DESCRIPTION OF THE DRAWINGS

FIG. 1 shows a device according to the present invention for identifying a driver of a vehicle, with the aid of a block diagram.

FIG. 2 shows a flow chart, which describes an identification method according to the present invention.

### DETAILED DESCRIPTION OF THE INVENTION

In the following exemplary embodiments, the present invention will be described on the basis of the operation of an electrically drivable bicycle. In addition, however, the present invention can also be used in motor vehicles such as passenger cars, trucks or in motorcycles.

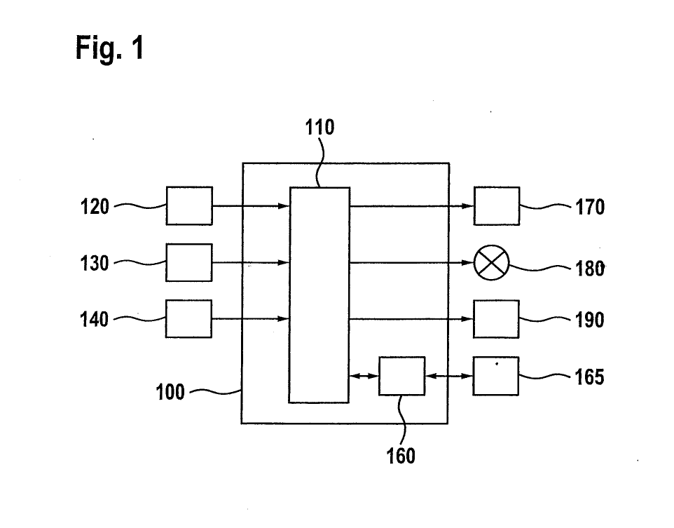

Device 100 according to the present invention, as it may be realized in a control unit of an electric bicycle, for instance, includes an evaluation unit 110, as shown in FIG. 1. This evaluation unit 110 records at least one operating parameter of the electric bicycle with the aid of a suitable sensor 120, 130 and/or 140, and compares the obtained variables with driver information stored in a memory 160. This driver information constitutes comparison data and/or related driver profiles, which represent the typical behavior of the driver. Via an interface, these comparison data can be read into memory 160 by an external module 165, or it can be queried therefrom. As an alternative or in addition, it may be provided that the evaluation unit stores the operating parameters in memory 160 in case of an unambiguous identification of the driver, for later comparisons or identifications. Also conceivable in this context, for example, is a mean value calculation in typical operating situations such as a power take-off behavior or cornering, across multiple driving situations detected in this way.

If the driver is unambiguously identified by evaluation unit 110, then motor 170 can be actuated accordingly, for instance by switching over from a basic operation in the form of a reduced engine torque, to completely exploitable motor assistance. As an alternative or in addition, display 180, the HMI or the control unit may be enabled as well, either partially or completely. Additionally, however, it is also possible to actuate further components 190 of the bicycle, for instance in order to adapt certain settings to the detected person. Conceivable in such a context are an adjustment of certain seat positions, displays in the HMI (e.g., user-individual displays, language selection), damping elements, steering wheel positions or advance settings for the gear group, for example.

For the detection of operating parameters that reflect an individual utilization of the bicycle and thus are suitable for deriving the driver identification, in particular, a torque sensor 120 may be provided, which records the torque of the foot pedal or the utilized motor, for example, and/or a rate of rotation sensor or (pedal) frequency sensor 130. In particular the individual pedaling in the form of the specifically generated torque or the rotational speed of the pedals may be utilized as indicator for the identification, e.g., when detecting a typical rocking pedal actuation. In addition, however, further operating or situational variables and, moreover, biometric parameters of the driver are detectable with the aid of suitable sensors 140. The acceleration of the bicycle or the pedals, the speed, the inclination of the bicycle or the ascending gradient of the vehicle within a predefined time period or at a detected speed may be mentioned as examples of operating parameters. With the aid of a suitable sensor, the GPS signals are able to be recorded as situational variable during the vehicle operation.

In addition, the recording and consideration of the altitude, especially in conjunction with other operating parameters, is possible, for instance as altitude profile or in the form of uphill/downhill gradients. The fingerprint, hand geometry, face geometry, the heart rate, the grip hold (and force) on the steering wheel, the weight or the weight distribution on the saddle, for example, are able to be recorded as biometric parameters, which are additionally taken into account for the identification. Pressure sensors, e.g., in the saddle or in the steering wheel, or also cameras may be used for detecting such parameters.

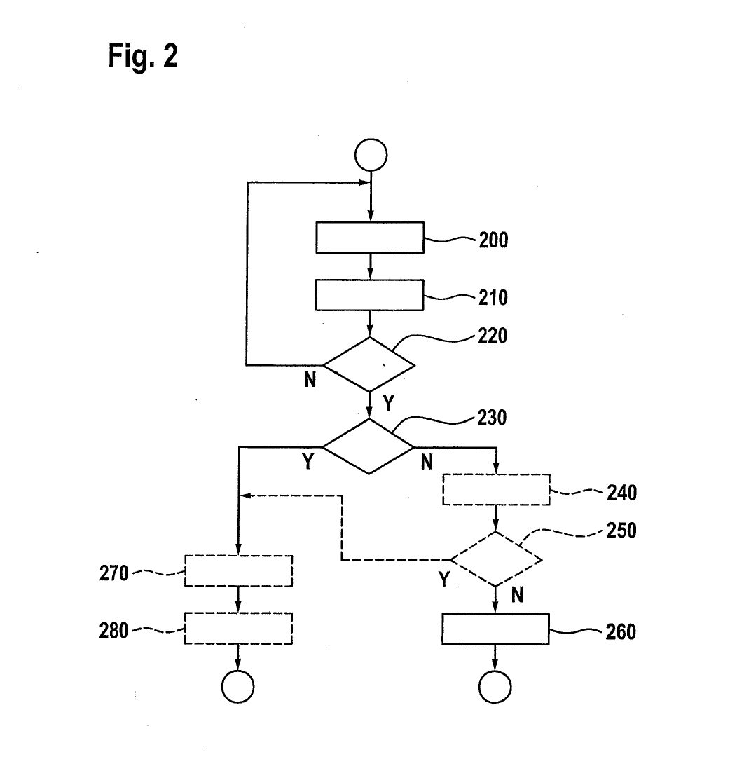

One possible development of the identification method according to the present invention is illustrated in the following text with the aid of the flow chart from FIG. 2. After the start of the method, which may run in an evaluation unit 110, for example, at least one operating parameter of the bicycle is recorded in a step 200. For verification purposes, it may optionally be the case that at least two operating parameters are recorded, which parameters represent different use behaviors. The recorded operating parameter(s) can optionally be stored in a memory 160, for instance for a median value calculation. In the next step 210, the at least one recorded operating parameter is compared to the stored (comparison) data or the stored driver profile. The stored data may be single data, temporally differentiated data, or mean value calculations. In the event that it is determined in next step 220 that the comparison does not allow an unambiguous identification, for instance because there are still too few operating variables available for the analysis, operating parameters are recorded anew in step 200. It is understood that the same physical operating parameters are recorded in this case.

If it is detected in step 220 that sufficient information is available for making an identification, the comparison of the operating parameters recorded in step 200 with the stored comparison data will be carried out in following step 230. If the recorded operating parameters do not match the stored data or the stored profile, then a request is output to the driver in an optional step 240 to input an individual ID, which may likewise be stored in memory 160, so that the use by the driver can be verified. As an alternative, it may also be provided to query biometric parameters of the driver at this instant, either automatically or manually. If it is detected in the following optional step 250 that the input ID is correct or the biometric data match at least one user profile, the method is terminated or continued with step 270. In the event that the identification in step 230 is unsuccessful, the ID is incorrect, or the biometric parameters do not match any of the stored driver profiles, then a restriction or complete blocking of the use of the bicycle may be provided in a further step 260. In such a restriction or blocking, the drive may be reduced to an emergency operation or be switched off completely, for instance. However, blocking may take place as well, in which case the bicycle can no longer be powered by muscle force, so that a possible thief will be unable to continue riding the bicycle, or the theft will at least be made more difficult. It is also conceivable that the bicycle can be driven only at a lower speed or has a predefined (residual) range. It is furthermore conceivable that an automatic notification will be sent to a predefined address, e.g., via SMS or telephone.

However, if it is detected in step 230 that the recorded driving behavior featuring the operating parameters in step 200 corresponds to at least one of the stored driver profiles, the method can be terminated in the least complicated case.

As an alternative, however, it is possible to send positive information to the system in a further step 270, for instance in order to enable additional functionalities of the bicycle or to switch them on in addition. Conceivable in this context are user-specific assistance modes, user-individual displays, e.g., of the driven miles, user-specific language selections or skinning of display instruments, for example.

Optionally, individually preferred settings may be adjusted on the components of the bicycle in a further step 280. The saddle position, the steering wheel setting, the setting of the damping elements or also the light orientation may be automatically adjusted to the identified driver.

In a further exemplary embodiment, not only an operating parameter but also a biometric parameter is recorded in step 200 at the same time, which is used in step 230 for identification purposes. Conceivable in this case, for instance, is that a pressure sensor or a resistance strain gauge is assigned to the saddle, which records the weight of the driver or the weight distribution on the saddle.

What is claimed is:

1. A method for identifying a driver of a vehicle, comprising:
acquiring at least one operating parameter of the vehicle;
performing an identification of the driver as a function of (i) the temporal behavior of the at least one operating parameter, and (ii) comparison data assigned to the driver; and
outputting one of a positive or negative identification signal as a function of the identification.

2. The method as recited in claim 1, further comprising:
acquiring a driver variable which represents a personal parameter of the driver, wherein the identification is performed additionally as a function of the acquired driver variable.

3. The method as recited in claim 2, wherein the driver variable includes at least one of the heart rate and the weight of the driver.

4. The method as recited in claim 2, wherein at least one of:
a torque of one of a foot pedal or a motor of the vehicle;
an acceleration of a foot pedal of the vehicle;
a rate of rotation of the motor;
a pedaling frequency of the foot pedal of the vehicle;
an inclination of the vehicle; and
an ascending gradient of the vehicle during operation of the vehicle
is acquired as the operating parameter and used for identifying the driver.

5. The method as recited in one of the preceding claims, wherein GPS signals are recorded while the vehicle is in operation and the identification is additionally performed as a function of the temporal change of the GPS signals, in particular.

6. The method as recited in claim 2, wherein at least one of a drive and an operating element of the drive is at least one of selectively activated and deactivated as a function of the one of the positive or negative identification of the driver.

7. A device for identifying a driver of a vehicle, comprising:
a memory for storing comparison data assigned to the driver; and
an evaluation unit configured to:
(i) record at least one operating parameter of a vehicle,
(ii) perform an identification of the driver as a function of (a) the temporal behavior of the at least one operating parameter, and (b) the comparison data assigned to the driver,
(iii) generate one of a positive or negative identification signal as a function of the identification.

8. The device as recited in claim 7, wherein the evaluation unit records a driver variable which represents a biometric parameter of the driver with the aid of at least one corresponding sensor, and wherein the identification signal is generated additionally as a function of the driver variable.

9. The device as recited in claim 8, wherein the evaluation unit uses at least one sensor to record during operation of the vehicle at least one of (i) a torque variable representing a torque of a foot pedal or a motor, (ii) an acceleration variable representing acceleration of a foot pedal of the vehicle, (iii) a rotation rate variable which represents the rate of rotation of the motor, (iv) a pedaling frequency variable of a foot pedal of a bicycle, and (v) an inclination variable of the vehicle, and (vi) an ascending gradient variable of the vehicle, as the at least one operating parameter.

10. The device as recited in claim 8, wherein the evaluation unit one of receives or generates at least one GPS signal while the vehicle is in operation, and wherein the identification signal is generated additionally as a function of the at least one GPS signal.

11. The device as recited in claim 9, wherein the evaluation unit one of activates a component of the vehicle or enables control of the component as a function of the identification.

12. The device as recited in claim 7, wherein the evaluation unit one of (i) deactivates a component of the vehicle , or (ii) blocks control of the component of the vehicle, if negative identification signal is present.
